(19) United States
(12) Patent Application Publication
(10) Pub. No.: US 2014/0071015 A1
(43) Pub. Date: Mar. 13, 2014

(54) TRIM ALGORITHM FOR A MEDICAL DEVICE ANTENNA

(71) Applicant: Jianli Zheng, Phoenix, AZ (US)

(72) Inventor: Jianli Zheng, Phoenix, AZ (US)

(73) Assignee: MEDTRONIC, INC., Minneapolis, MN (US)

(21) Appl. No.: 13/610,919

(22) Filed: Sep. 12, 2012

(51) Int. Cl. H01Q 1/50

(52) U.S. Cl. 343/860

(57) ABSTRACT

The disclosure pertains to tuning the impedance of an antenna impedance matching circuit according to operating parameters. The algorithm causes simultaneous adjustment of the impedance of a plurality of variable components of an antenna impedance matching circuit. The algorithm includes selecting between at least one value over a plurality of values in an array. The selected value represents a set of discrete values for each of the plurality of variable components. The plurality of variable components are adjusted to match the selected discrete values. An input signal is applied to the impedance matching circuit after each adjustment, and the magnitude of the signal received in response to the input signal is measured and compared to the magnitude of signal measured for previously set values. A determination is made as to the values of the plurality of variable components that result in the signal with the greatest magnitude.

### FIELD

The disclosure relates generally to implantable medical devices and, in particular, to tuning an impedance matching network of the implantable medical devices' radio frequency antenna.

### BACKGROUND

The use of wireless communications in implantable medical devices is well known in the art. Using both inductive and radio frequency communications, data and commands may be transmitted to an implantable medical device and telemetry data may be received from the implantable medical device. In a radio frequency application, the implantable medical device may utilize a relatively small, space-efficient antenna coupled to an internal transceiver positioned in proximity of the internal antenna to establish a communication link with an antenna of an external device.

The effective range and rate of radio frequency communication may depend in part on a degree to which the impedance of the antenna of the external device matches the impedance of the antenna of the internal device. The closer the impedance match, the clearer the signal between the two antennas and the greater the rate of communication between the antennas. Beyond the impact of variance in the componentry utilized in wireless communications, the environment in which the implantable medical device operates may have an impact on the perceived impedance of the internal antenna. The sensitivity of the antenna to the environment makes the task of matching the impedance of the antenna and transmitter challenging. Numerous attempts have been made to address the matching problem.

For instance, U.S. Pat. No. 7,409,245, Larson et al., discloses a variable antenna matching network for an implantable antenna. Changes in the patient's body position, weight, composition or other factors may change the antenna efficiency and hinder communication. The disclosed circuit may automatically adjust a matching network for an implanted transceiver to dynamically maximize transmission and reception by controlling the selected value of a plurality of capacitors, inductors and resistors.

However, because of the premium placed on making implantable medical devices relatively small, many internal antennas are not tunable. As a result, manufacturers of implantable medical devices have traditionally made a compromise between maximizing wireless communication efficiency and range and keeping the internal volume of the implantable medical device small. As a result, it is desirable to test the antenna during device manufacture to account for manufacturing process variations.

### SUMMARY

For maximum efficiency, the impedance of an antenna should be matched to the impedance of its transceiver. In practice, the matching of antenna to the transceiver circuit is achieved by the impedance matching network. The matching network transforms the impedance required by the transmitter to that presented at the transmitter end of the feedline. In effect, the matching network is a transformer that matches the impedance of the transmitter and the antenna while also tuning out the reactance, making the load to the transmitter resistive, and putting the voltage and current in the system in phase.

In one embodiment, an algorithm is disclosed for tuning the impedance of an antenna impedance matching circuit according to operating parameters. The operating parameters control the impedance of a plurality of variable components of the impedance matching circuit. The algorithm causes simultaneous adjustment of the impedance of the plurality of variable components.

In an exemplary embodiment, the impedance matching circuit operates across a plurality of Medical Implant Communications Service (MICS) channels. The algorithm operates to maximize the magnitude of the minimum power signal across the plurality of MICS channels.

In an embodiment, the algorithm includes selecting at least one value from a plurality of values in an array of impedance matching possibilities. The selected value represents a set of discrete values for each of the plurality of variable components. The plurality of variable components are adjusted to match the selected discrete values.

In an embodiment of the algorithm, an input signal is applied to the impedance matching circuit after each adjustment, and the magnitude of the signal received in response to the input signal is measured and compared to the magnitude of signal measured for previously set values. A determination is made as to the values of the plurality of variable components that result in the signal with the greatest magnitude.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments will hereinafter be described in conjunction with the appended drawings wherein like numerals/letters denote like elements, and:

FIG. 1 is a schematic diagram illustrating one embodiment of a communication system for communication between an implantable medical device and external unit;

FIG. 2 is block diagram illustrating one embodiment of a portion of an implantable medical device circuit;

FIG. 3 is an electrical schematic diagram illustrating one embodiment of a portion of a circuit of implantable medical device;

FIG. 4 is an electrical schematic drawing illustrating one embodiment of a sacrificial component circuit of FIG. 3;

FIG. 5 is a graph depicting an array of impedance matching possibilities in accordance with an embodiment of an impedance matching network; and

FIG. 6 illustrates a flowchart illustrating one embodiment of a trim algorithm for optimizing an impedance of the matching network.

### DETAILED DESCRIPTION

Advancements in the implantable medical device technology have led to an increasing use of wireless applications. The implantable medical device may communicate with other devices in accordance with the Medical Implant Communications Service (MICS) band regulation. The MICS band regulation defines communication requirements for the 402-405 MHz frequency band. In accordance with the MICS band regulations, the frequency band may be divided into ten MICS channels with each channel corresponding to a 300 kilohertz (kHz) sub-band.

The wireless communications are typically between one or more transmitting devices, each of which transmits radio signals to one or more receiving devices. The transmitting and/or receiving device(s) may reside in one or more implantable medical devices or external medical devices to enable communication between the devices. On receipt of a signal from the transmitting device, the receiving device takes appropriate action. The transmitting device typically comprises a transmitter, an antenna and a power source while the receiving device typically comprises a receiver, an antenna and a power source. In some embodiments, the transmitter and receiver may be housed in a single IC chip (transceiver) thereby sharing a common antenna. Power consumption in an implantable medical device is generally a critical factor for sustained longevity of the device and therefore the communications are preferred to utilize the minimum power possible.

In various embodiments, power consumption in the implantable medical device (IMD) is optimized by providing an antenna with an optimally-tuned antenna impedance matching circuit. While real-time, tunable impedance matching circuits have been utilized to improve telemetry communication in wireless applications, such circuits typically expend a significant amount of implantable medical device resources including increasing the internal volume of the implantable medical device, expending computing power of the implantable medical device, and reducing the service life of a power source (for instance, a battery) of the implantable medical device.

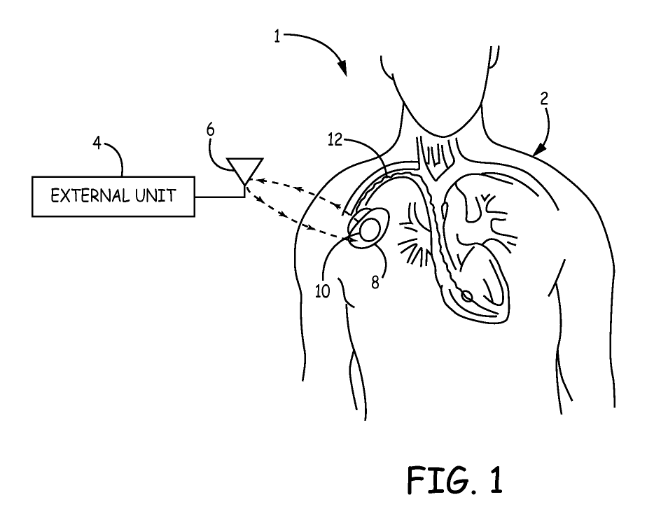

FIG. 1 is a schematic diagram illustrating one embodiment of a communication system 1 for communication between an implantable medical device 8, which includes lead 12 and antenna 10, and external unit 4. In one embodiment, implantable medical device 8 is an implantable cardioverter-defibrillator, but the embodiments of the present invention are equally applicable to other types of medical devices, including both implantable medical devices and external medical devices. For example, implantable medical device 8 may provide electrical stimulation therapy (e.g., a combination at least one of pacing, defibrillation, cardioversion or cardiac resynchronization therapy). In other instances, implantable medical device 8 may provide electrical stimulation therapy to other regions of the body, e.g., a spine, brain, or the like. In yet another example, implantable medical device 8 may provide drug delivery therapy or other therapies in addition to or instead of electrical stimulation therapy.

In addition to or instead of providing therapy, implantable medical device 8 may be capable of sensing physiological events of the heart of patient 2 via electrodes of lead 12. Implantable medical device 8 may also sense one or more physiological or biological conditions of other regions of patient 2 via electrodes of lead 12 or other sensors on lead 12, within implantable medical device 8 or separate stand-alone sensors. Antenna 10 is used to communicate with external unit 4 and may be any suitable device capable of sending or receiving electromagnetic waves, including for example a surface mounted antenna, an inductor, or a half-wave strip.

External unit 4 is a device, such as a programmer or home monitor, capable of bi-directional communication with implantable medical device 8. External unit 4 includes antenna 6, which may be any suitable type of radio frequency antenna capable of communicating in the desired radio frequency (RF) frequencies with implantable medical device 8, and may be located inside or outside of a housing of external unit 4.

Implantable medical device 8 includes an adjustable impedance matching circuit for impedance matching the antenna 10 to a radio frequency transceiver within the device can of implantable medical device 8. By adjusting the impedance matching circuit between different predetermined impedances, operation of antenna may be increased. Moreover, providing the capability to adjust between different predetermined impedances allows better impedance matches to be achieved between antenna 10 and the transceiver of implantable medical device to account for variations that may arise from the manufacturing process. Additionally, a variety of antennas 10 having different impedances may be used with a single radio frequency transceiver used in different implantable medical devices without having to use a separate impedance matching circuit for each of the variety of antennas. Therefore, both development times and costs are reduced while improving communication performance.

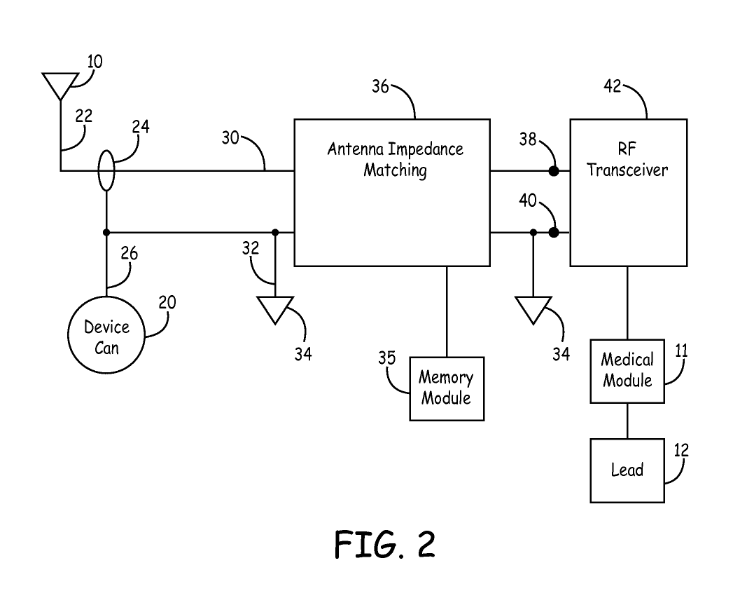

FIG. 2 is block diagram illustrating one embodiment of a portion of an implantable medical device circuit. The circuit includes antenna 10, the implantable medical device 8 device can 20, an antenna impedance matching circuit 36, and a radio frequency transceiver 42. Antenna 10 may be electrically coupled to antenna impedance matching circuit 36 through signal path 22. Signal path 22 passes through a feed through 24 of device can 20. Feed through 24 is electrically coupled to device can 20 through signal path 26. Signal paths 22, 26 are coupled to the impedance matching circuit 36 via signal paths 30, 32, respectively.

Medical module 11 is coupled to lead 12 and provides sensing and/or therapy functions consistent with those commonly provided in implantable medical devices such as pacemakers, cardioverters/defibrillators, neurological stimulators and drug infusion devices. In various embodiments, medical module 11 is operatively coupled to radio frequency transceiver 42 and receives instructions and transmits data to external unit 4 (FIG. 1) by way of radio frequency transceiver 42. In certain embodiments, medical module 11 is directly coupled to radio frequency transceiver 42. In alternative embodiments various electronics modules commonly known in the art are coupled between radio frequency transceiver 42 and medical module 11 in order to facilitate communication between radio frequency transceiver 42 and medical module 11, including controllers and data storage.

A first output of antenna impedance matching circuit 36 is electrically coupled to a first input of radio frequency transceiver 42 through signal path or node 38. A second output of antenna impedance matching circuit 36 is electrically coupled to a second input of radio frequency transceiver 42 and to common or ground 34 through signal path or node 40.

Antenna 10 receives radio frequency signals from external unit 4 (FIG. 1) and transmits radio frequency signals to the external unit 4. Feed through 24 is hermetically sealed such that circuits within device can 20 are protected when implanted within a patient. In one embodiment, device can 20 includes titanium or other suitable material. Antenna impedance matching circuit 36, radio frequency transceiver 42, and other implantable medical device 8 circuitry (not shown) is enclosed within device can 20.

In other embodiments, high voltage protection circuit (not shown) may be coupled, for example, between the antenna 10 and the antenna impedance matching circuit 36. The high voltage protection circuit protects implantable medical device 8 circuitry from high voltages on the input signal paths 22 and/or 26.

The antenna in the transmitting device is a load and the device's transmitter. Maximally efficient power transfer between a transmitter and an antenna may be achieved when the transmitter impedance is a complex conjugate of the antenna impedance. However, the sensitivity of antenna impedance to its environment makes the task of matching the impedances of antennas and transmitters challenging.

Antenna impedance matching circuit 36 may be tuned (or trimmed) to match the impedance of antenna 10 to the impedance of radio frequency transceiver 42. Take, for instance, an embodiment in which radio frequency transceiver 42 has a receiver input impedance of 50 ohms and a transmitter output impedance of 50 ohms between nodes 38 and 40, and antenna 10 has an impedance less than 50 ohms Antenna impedance matching circuit 36 may be tuned to match the lower impedance of antenna 10 to the higher impedance of radio frequency transceiver 42. Antenna impedance matching circuit 36 can be adjusted (as will be described below) to match the impedance of antenna 10 to the impedance (or as close to as possible) of radio frequency transceiver 42 in different operating environments. For example, antenna impedance matching circuit 36 may be tuned to have a first impedance corresponding to or closely matched with the impedance of the antenna operating in air and tuned to have a second impedance corresponding to or closely matched with the impedance of the antenna operating in the body environment while implanted in a patient.

Antenna impedance matching circuit 36 can also be adjusted to match different antennas 10 having different impedances to radio frequency transceiver 42 in addition to or instead of adjusting the impedance in different operating environments. In this way, multiple implantable medical devices 8 having different designs and antenna designs having different impedances can use the same antenna impedance matching circuit 36 and radio frequency transceiver 42. Therefore, a unique antenna impedance matching circuit 36 and/or radio frequency transceiver is not needed for each individual implantable medical device 8 design or antenna design.

In an embodiment, impedance matching circuit 36 is coupled to memory module 35. In such embodiments, codes to configure impedance matching circuit 36 may be stored in memory module 35 and transmitted to impedance matching circuit 36 at appropriate times. The appropriate times may be preprogrammed or automatically determined on the basis of conditions sensed by medical module 11. For example, antenna impedance matching circuit 36 may be configured to dynamically tune the impedance matching circuit 36 when the environment changes, e.g., from air to the implanted environment upon detecting a cardiac signal via one of the leads. Detection of a cardiac signal may indicate that implantable medical device 8 is implanted within patient 2. In alternative embodiments, commands may be transmitted from external unit 4 by way of antenna 10 and identified by radio frequency transceiver 42 or a controller coupled to the device that is configured to identify the command and cause the code to be transmitted from memory module 35 to impedance matching circuit 36 to adjust the impedance. The command may, for example, be transmitted by a programmer after implantation.

On the basis of the codes transmitted to impedance matching circuit 36, impedance matching circuit 36 may be reconfigured in a manner described in detail below. In certain embodiments, memory module 35 may also be coupled to radio frequency transceiver 42 and may be loaded with newly transmitted codes. In particular, in various embodiments, memory module 35 may be pre-stored with derived codes corresponding to predetermined selectable configurations. In certain embodiments, such configurations relate to implantable medical device 8 operating outside of patient 2, and implantable medical device operating implanted within patient 2.

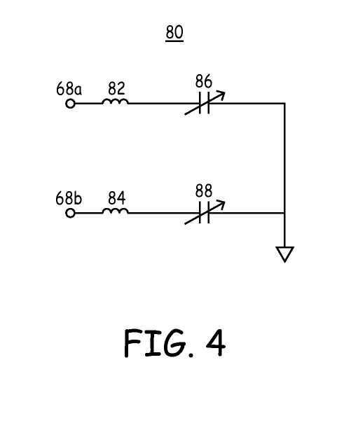

In order to derive such codes, antenna 10 may be coupled to sacrificial components (FIG. 4) that simulate the various conditions (e.g., body environment) in which implantable medical device 8 may operate. The sacrificial components may suitably be used during device manufacture of the implantable medical device 8. By connecting a power meter (not shown) to the RF port (not shown) of the implantable medical device, the impedance matching circuit 36 can be tuned to maximize the transmit power in the simulated body environment. In alternative embodiments, the sacrificial components relate to other conditions in which implantable medical device 8 may be operating, and may be obtained either on the basis of simulated test loads or through configurations predetermined in ways related to devices of the same type as implantable medical device 8 but not necessarily to implantable medical device 8 individually.

Radio frequency transceiver 42 includes a receiver for receiving radio frequency signals transmitted from external unit 4 via antenna 6 to antenna 10. Radio frequency transceiver 42 also includes a transmitter for transmitting radio frequency signals to external unit 4 via antenna 10. Transceiver 42 is electrically coupled to additional circuitry (not shown) within implantable medical device 8. The additional circuitry provides therapies and/or senses physiological events of the patient.

In one embodiment, the output power of radio frequency transceiver 42 is checked periodically (or often enough to be nearly continuous). The output power is greatest when antenna 10 is properly matched to radio frequency transceiver 42. In other embodiments, the received signal strength is maximized to properly impedance match antenna 10 to radio frequency transceiver 42 maximizing the output power or received signal strength to compensate for antenna feedpoint impedance variations as can occur (i.e. a hand-held instrument or an implant prior and after implant).

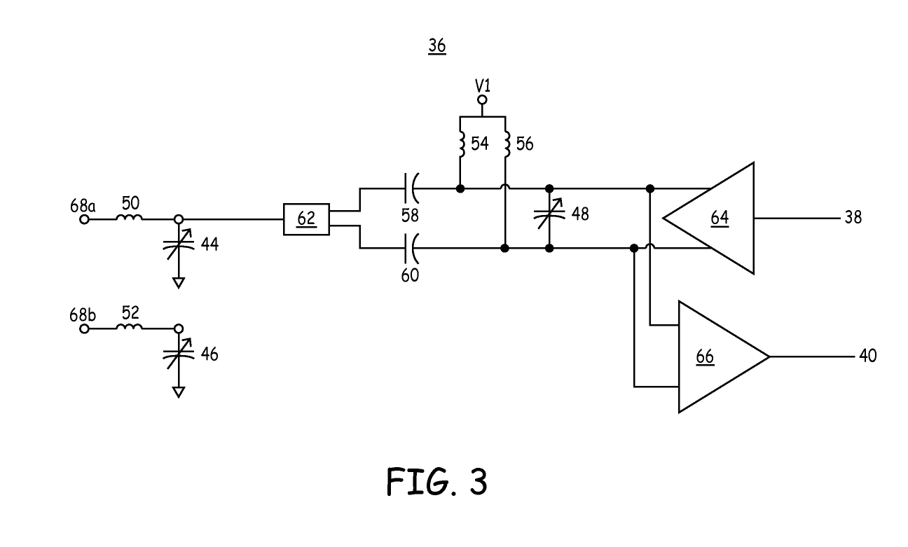

FIG. 3 is an electrical schematic diagram illustrating one embodiment of a portion of a circuit of implantable medical device 8. The circuit includes antenna 10, device can 20 and antenna impedance matching circuit 36. In one embodiment, antenna impedance matching circuit 36 includes a plurality of adjustable components such as inductors and capacitors that are utilized for impedance matching antenna 10 to radio frequency transceiver 42. In various alternative embodiments, antenna impedance matching circuit 36 includes various combinations of inductors and variable capacitors. Such alternative embodiments may include embodiments with no inductors which consist of capacitors, and embodiments with no capacitors which consist of inductors.

In the illustrative embodiment of FIG. 3, antenna impedance matching circuit 36 may include discrete components such as capacitors 58 and 60, variable capacitors 44, 46 and 48, inductors 50, 52, 54 and 56, a filter 62, and amplifiers 64 and 66. Antenna 10 is electrically coupled to the RF input ports 68a, 68b through signal paths 22 and 30. Signal path 22 passes through a feed through 24 of device can 20 and becomes signal path 30. Feed through 24 is electrically coupled to device can 20 through signal path 26 that becomes signal path 32.

The RF input ports also couple to the inductors 50, 52 and the input signal is provided to the filter 62 that may be a surface acoustic wave resonator (SAW). The amplifiers 64 and 66 may perform power amplification of the transmitted and received signals, respectively. The received signal may be provided to other circuitry, such as a processor, of implantable medical device 8 while the signal to be transmitted is provided by other circuitry (not shown) of the implantable medical device 8.

The variable capacitors 44, 46, and 48 each provide a variable capacitance for impedance matching the antenna 10 to radio frequency transceiver 42. The capacitance of the variable capacitors 44, 46, and 48 are adjusted simultaneously due to the dependency of each of the variable capacitors. In other words, the optimization of the impedance is achieved by tuning all three variable components simultaneously. Otherwise, tuning of the three components serially, i.e., one after the other successively, would result in detuning of the previously tuned component(s).

In one embodiment, each of the three variable capacitors 44, 46, 48 includes a multi-bit register that is coupled to a capacitor bank. The three variable capacitors 44, 46, 48 can be adjusted once at factory calibration during device manufacture, adjusted in response to a command from external unit 4, and/or automatically adjusted to impedance match antenna 10 to radio frequency transceiver 42 for optimal performance during operation in the implanted environment. By adjusting the impedances of the three variable capacitors 44, 46, 48, the effective combined impedance of the discrete components including capacitors 58 and 60, variable capacitors 44, 46 and 48, and inductors 50, 52, 54 and 56 presented at the RF input 68a, 68b can therefore be matched to the impedance of antenna 10 in any environment.

In electrical circuit design, it is a common practice to use trim registers to fine tune the circuit to achieve the circuit's best performance and counterbalance variations in the operating environment of the circuit. In certain cases, more than one trim register exists that needs to be trimmed simultaneously to optimize the performance. This is because the registers cannot be trimmed separately without interaction due to the interdependency of the performance of the components to which the trim registers are coupled. An example of a circuit that can be tuned utilizing the trim registers is the impedance matching network 36.

In the embodiment of FIG. 3, the tunable components comprise capacitors 44, 46, 48. Each of the tunable components is coupled to a capacitor bank that is controlled by a multi-bit register. For example, a 5 bit register may be employed that provides 32 discrete values. In the example, each of the 32 discrete values of the 5 bit register corresponds to a discrete capacitor value. As indicated, the operation to optimize the value of all three tunable components is interdependent on the components and the maximum power for the antenna changes in response to each change of any of the capacitor values.

To achieve minimum insertion loss for a particular antenna design, the three trim registers need to be simultaneously trimmed to maximize the transmitter power and receiver sensitivity. Trimming of the trim registers is performed by ramping up or down the register that switches the capacitor bank associated with each of the respective tunable components. By ramping up or down each register, the value of the tunable component is adjusted to correspond to a desired trim value. The trimming simultaneously adjusts the values of the plurality of tunable components.

During the trim, a signal is applied through the transmitter (i.e., the transmitter is turned on) and the effective output power is monitored. The optimization of the impedance matching network is completed when the maximum output power is found.

In embodiments in which the IMD is configured for transmission across multiple MICS channels, there may be a variation in the maximum output power for each of the MICS channels. The goal of the trim procedure is to maximize the minimum power across all channels (the discussion in this disclosure contemplates an example with 10 MICS channels) of the MICS band. The optimal efficiency of the transmitter circuit is obtained by determining the optimal combination of the tunable components that maximizes the least transmitter power across all 10 MICS channels. In the example embodiment where three tunable components are controlled by a 5 bit register with ten (10) MICS channels, an exhaustive search will require 327680 (32×32×32×10) power measurements taking approximately 983 minutes. This is assuming that each power measurement takes approximately 0.18 seconds.

Performing the exhaustive search would require a lot of time in the device manufacture and or operating environment as well as consume a significant amount of power if the search were to be performed in the body environment, e.g., when the IMD is implanted in a patient.

The trim algorithm of this disclosure reduces the number of power measurements while facilitating a determination of the optimal component values. The algorithm reduces the number of power measurements by enhancing the search performed across the plurality of tunable components for the combination of component values that provide optimal power transmission. Although the trim algorithm is described as multi-dimensional, i.e., the matching network has a plurality of tunable components, it should be understood that the algorithm can be implemented with a single tunable component. As can be expected, the complexity of the multidimensional trim algorithm depends on the number of tunable components. In the case of a single tunable capacitor controlled by the multi-bit register in a single MICS channel, the number of possibilities and power measurements is quite limited in comparison to the possibility of power measurements in an embodiment with multiple tunable components operated over multiple channels.

FIG. 4 is an electrical schematic drawing illustrating one embodiment of the sacrificial component circuit 80 that may be used to simulate an operating environment of antenna 10 during device manufacture. In this embodiment, sacrificial component circuit 80 is connected at nodes 68a, 68b to couple to the impedance matching circuit 36. The components 82, 84, 86, 88 in sacrificial component circuit 80 may be selected to emulate the impedance of a patient's body environment. Thus, the combined impedance of the antenna 10 and sacrificial component circuit 80 emulate the impedance to which the impedance matching network 36 is to be tuned. The impedance matching network 36 may 10 be tuned by adjusting the values of variable capacitors 44, 46, and 48 to match the impedance of antenna 10—with the sacrificial component circuit 80 contributing to the antenna 10 impedance. The sacrificial component circuit 80 may subsequently be de-coupled from nodes 68a, 68b to eliminate the impedance emulating the body environment.

Owing to the differences in different patient's body topologies, disease state, and various other factors, the body impedance will vary from one patient to another. Therefore, alternative embodiments may include more than one sacrificial component circuit 80 or in other alternatives, antenna 10 may be connected to an external sacrificial component circuit 80 through nodes 68a, 68b.

The tunable impedance matching network of the present disclosure facilitates optimization of the transmitter circuit's power and receiver circuit's sensitivity for different antenna designs. Such antenna designs are disclosed in commonly assigned U.S. Pat. No. 8,219,204 issued to Duane Mateychuk. The tunable impedance matching network includes a plurality of tunable components.

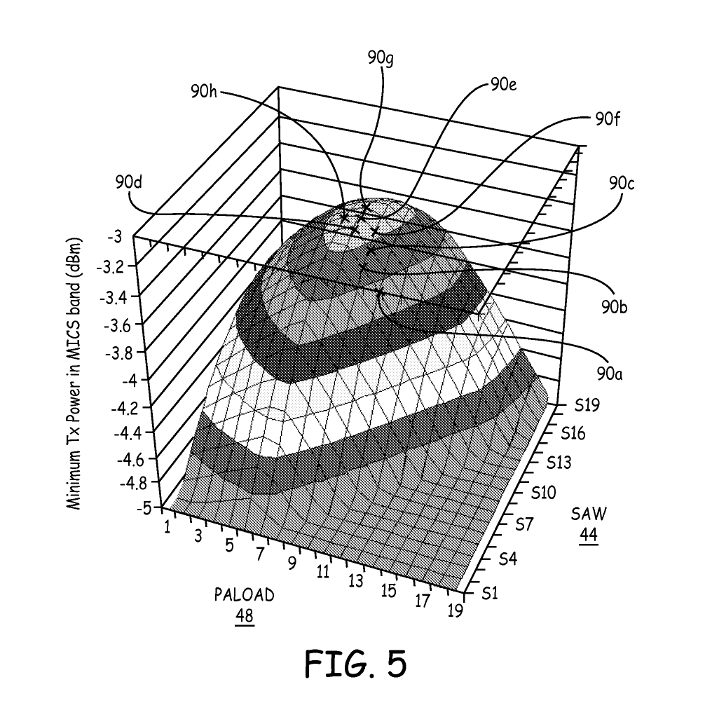

FIG. 5 shows an array of impedance matching possibilities in accordance with one embodiment of a given impedance matching network. The graphically-depicted impedance matching network possibilities correspond to an embodiment having two tunable components, e.g., 44, 48. The graph of FIG. 5 depicts the impedance matching network possibilities plotted on a three dimensional X, Y, Z axis chart. The horizontal (X) axis of the chart represents the discrete values for the tunable component PALOAD (48), the vertical (Y) axis represents the discrete values for the tunable component SAW (44), whereas the coordinate intersecting the X, Y axis, the Z axis, represents the power values that would be measured following transmission of a signal from the antenna with the tunable components having the corresponding values indicated in the graph. The array of the plurality of impedance matching possibilities is depicted graphically with the multiple values collectively forming a “hill.” One of the values at the peak of the hill represents the optimal trim value for the plurality of adjustable components. The values depicted at the intersection of the lines of the hill collectively represent the search space within which an optimal impedance value can be found. These values comprise the plurality of impedance matching value possibilities.

In accordance with some embodiments of the multi-dimensional trim algorithm, a search is performed for the one or more of the values (e.g., 90a-h) at the peak of the hill that results in the optimal trim value. The optimal trim value represents the values of the tunable components that result in an optimization of the impedance of the matching network and that produce the maximum output power of the antenna. The optimal trim value for the plurality of adjustable components of the impedance matching network corresponds to the values of the adjustable components that provide an output impedance of the matching network that is equal to or approximates 50 ohms.

In accordance with operation of the multi-dimensional trim algorithm, the optimal trim value is selected by tuning each of the plurality of components simultaneously to a respective one of the plurality of component values in the combination of individual values associated with a given trim value. As previously stated, the operating environment of the antenna impacts the overall impedance of the antenna. For example, the impedance of the antenna in air will vary from the impedance of the antenna implanted in the human body. Once tuned, the matching network is generally optimal for only one operating environment. Tuning the impedance of the antenna in air during device manufacture may result in an antenna that exhibits excessive power loss when the antenna is implanted. Moreover, the implant conditions in different bodies, depth of the implanted IMD in the body, and numerous other factors will result in a variation of the antenna impedance from one patient to another. Therefore, it may be desirable to dynamically tune the plurality of adjustable components from time to time during operation of the IMD.

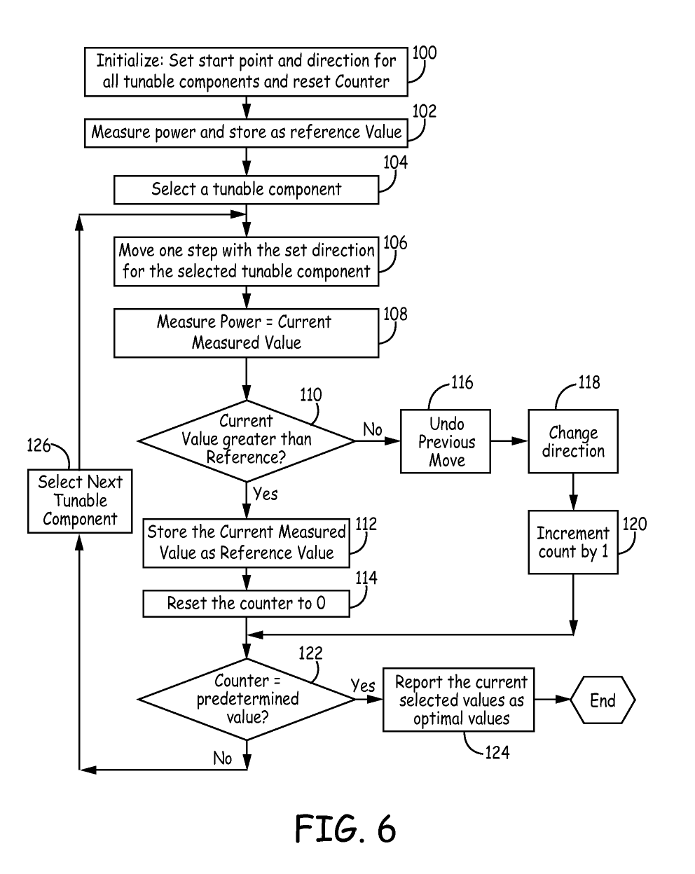

FIG. 6 illustrates a flowchart illustrating one embodiment of a trim algorithm for optimizing an impedance of the matching network. The trim algorithm illustrated in FIG. 6 is multi-dimensional, i.e., the matching network has a plurality of tunable components. However, the algorithm can be implemented with a single tunable component—such an algorithm would effectively be single dimensional. The various tasks performed in connection with the process of FIG. 6 may be performed by software, hardware, firmware, or any combination thereof For illustrative purposes, the following description of the process in FIG. 6 may refer to elements mentioned above in connection with FIGS. 1 to 5. In practice, portions of the process may be performed by different elements of the described system; e.g., implanted sensors, an IMD, or an external monitoring device. It should be appreciated that the process may include any number of additional or alternative tasks, the tasks shown in FIG. 6 need not be performed in the illustrated order, and the process may be incorporated into a more comprehensive procedure or process having additional functionality not described herein. In accordance with the illustrated embodiment of FIG. 6, impedance matching values are selected from the array of the plurality of impedance matching possibilities, such as that depicted graphically in FIG. 5, to maximize the minimum power of the antenna. While not intended to be limiting, the algorithm for optimizing the impedance of the matching network is particularly useful in instances where the array of the plurality of impedance matching possibilities does not contain any: local optimums, flat valleys, or diagonal ridges. The algorithm may also have applicability where measurement repeatability is better than the smallest trim step size.

Referring to FIG. 6, the algorithm is initialized by selecting the starting point in the array of the plurality of impedance matching values as well as a first desired path along which subsequent values will be selected (100). The selected values and path may be guided by empirical values measured in historical tests. Such historical tests may cycle through all the impedance matching value possibilities for each antenna design or categories of operating environments. The memory contents of prior test sequences may also be cleared for the newly initiated test. In addition, a counter that counts the number of consecutive direction changes may be reset to zero. At task 102, the parameter to be optimized is measured. In this example, the parameter is the minimum transmit power across the ten (10) MICS channels. The minimum transmit power may be measured by providing an input signal at the RF input node and the resulting transmit power signals across all 10 MICS channels measured. The magnitude of the minimum power signal across the 10 MICS channels is identified and stored as the reference value that is to be used for comparison with subsequently measured minimum power signals across the MICS channels during the trim procedure.

The algorithm proceeds at task 104 by selecting a first tunable component to be adjusted. In accordance with the disclosure, the value of the tunable component is adjusted by selecting the value in the array of the plurality of impedance matching values that is adjacent to the currently selected value within the currently presently selected direction set by the desired set path (106). In other words, the value for the tunable component is adjusted by moving one step in the set path.

The transmit power of the antenna is subsequently measured in response to adjusting the value of the selected tunable component (108). For measurement of the transmit power, an input signal may again be applied at the RF input node and the resulting transmit power measured. In other words, for multi-channel MICS band capable devices, the power measurement is performed across all the channels. The least measured power value is identified and designated the currently measured value. The magnitude of the currently measured value for the current iteration may be stored in a memory location for comparison with the magnitude of the reference power measurement value obtained in a prior test iteration. At task 110, the algorithm performs a comparison between the currently measured value and the reference value (110).

If the currently measured value indicates a positive change, (in this embodiment, if the current power value is greater than the reference power value), the move direction remains unchanged and the stored reference value is replaced with the currently measured value (112). The counter is also reset to the value “0” (114).

Returning to task 110, if the currently measured value indicates a negative change, (in this embodiment, if the current power value is less than the reference power value), the algorithm undoes the last executed move. In other words, the algorithm re-adjusts the value of the tunable component back to the value it was prior to the move (116). The currently measured value is also discarded and the reference value remains unchanged. The algorithm proceeds to change the direction of the selection of values in the array of the plurality of impedance matching possibilities (118). The change in direction also sets a new path in the array for the values that are to be subsequently tested along that direction. While not indicated in the flowchart, it may be desirable to store in a memory location the directions that have already been tested especially in the case of a multi-dimensional array. With the change in direction, the counter value is incremented by the value “1” (120).

Proceeding from task 114 or task 120, the algorithm proceeds to compare the value of the counter to a predetermined value (122). The counter value represents the number of consecutive direction changes. The predetermined value is equal to the value: (number of tunable components multiplied by two) minus one i.e., ((number of tunable components X 2)−1). In the exemplary embodiment having three multi-bit registers for the three variable capacitors that value is five ((3×2)−1).

Responsive to the comparison indicating that the value of the counter is equal to the predetermined value, the impedance matching values currently selected from the array of the plurality of impedance matching values are reported as the optimal values for the tunable components (124).

In the illustrative embodiment, the trim algorithm changes the values of the tunable components in a round-robin fashion, i.e., changing the value of the first tunable component and performing tasks (106-122) and then changing the value of the subsequent (second, third and as many as applicable) tunable components—if any—while stepping through tasks (106-122) for each of the tunable components in a serial manner. Assuming the value of the counter is still less than the predetermined value upon performing these tasks for each of the tunable components once, the same tasks may again be repeated a second or as many subsequent times as needed until the counter value reaches the predetermined value. In the alternative embodiment of a single tunable component, only one component is present and therefore the sole tunable component remains selected for the next iteration of the tasks (106-122).

As such, in the multi-dimensional trim algorithm, if the comparison indicates that the value of the counter is less than the predetermined value, the algorithm proceeds to select the next tunable component (126). If the counter value is equivalent to the predetermined value, that means all moves in all directions result in a decrease in power efficiency, which signifies that the optimal values for the tunable components have been attained.

In other words, the algorithm selects the next tunable component and repeats the tasks (106-122) and then selects the next tunable component, if applicable, and repeats the tasks (106-122) for each tunable component and so on and so forth. A second iteration is then performed for each of the tunable components, again beginning with the first through the last applicable component with the tasks being performed as described above.

Furthermore, the move direction is changed and the counter is incremented in response to the move resulting in selection of a value that is beyond the tuning range. For example, with a 5-bit tunable register, the tuning range is 0-31.

An example illustration of the searching performed using the multi-dimensional trim algorithm of the embodiment in FIG. 6 is provided below. This example is described in conjunction with the graphical illustration of the array of impedance matching possibilities in FIG. 5. The multi-dimensional trim algorithm, illustrated in FIG. 5 is a two-dimensional trim algorithm, i.e., two tunable components that may be initiated by testing the power associated with the trim value 90a and terminate with the determination that the optimal trim value is 90e. The sequence for testing the trim values in this path would be 90a, then 90b, then 90c, then 90d, then 90e, then 90E After finding that the power associated with the values at 90f is less than the power at 90e, the algorithm changes direction by returning to 90e and selecting the values at 90g. Again, the values at 90g will be less than those at 90e and the algorithm therefore changes direction by returning to 90e and selecting the value at 90h. The values at 90h, also resulting in a power measurement that is less than the power associated with the values at 90e determines that the values at 90e. The direction is again changed returning to 90e. As is visually depicted, there are no other adjacent values and therefore the 90e value is optimal. In the algorithm, each of the direction changes resulting from a decreased power measurement at 90f, 90g, and 90h cause the counter to be incremented by 1. Therefore, after the power measurement 90h, the counter reaches the value 3, which is equivalent to the predetermined value for this example. Therefore, the algorithm determines that the value at 90e is the optimal value.

Techniques and technologies have been described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of IMD configurations, medical device therapies, and monitoring/diagnostic equipment, and that the system described herein is merely one suitable example.

For the sake of brevity, conventional techniques related to ventricular/atrial pressure sensing, IMD signal processing, telemetry, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

The description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematics shown in the figures depict exemplary arrangements of elements, additional intervening elements, devices, features, or components may be present in an embodiment of the depicted subject matter.

The system embodiments may be described herein with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits.

When implemented in software or firmware, various elements of the systems described herein (which may reside at an IMD, an external monitor device, or elsewhere in the system environment) are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

What is claimed is:

1. A method for optimizing an impedance matching network coupled to an antenna, comprising:
concurrently tuning a plurality of adjustable components of the impedance matching network iteratively over a plurality of matching values selected from an array, wherein each of the matching values selected from the array represents a discrete value for each of the plurality of components;
applying an input signal to be transmitted through the antenna in response to the tuning; and
measuring a magnitude of the transmitted power by the antenna in response to the tuning and the applied signal, wherein each successive iteration of the tuning is performed by selecting a different value within the array in response to the relative magnitude of the measured transmitted power for an immediately preceding iteration.

2. The method of claim 1, wherein each of the discrete values of the plurality of adjustable components is obtained by selectively adjusting a respective one of a plurality of multi-bit registers coupled with the plurality of adjustable components.

3. The method of claim 1, wherein the tuning of the plurality of adjustable components over the plurality of matching values within the array is performed by selecting a matching value that is adjacent to a currently selected matching value.

4. The method of claim 1, wherein an initial value for each of the adjustable components is based on historical value.

5. The method of claim 1, further comprising performing the concurrent tuning, applying, and measuring steps for a plurality of MICS channels.

6. The method of claim 1, wherein the array is one of a two-dimensional, three-dimensional, and four-dimensional array.

7. The method of claim 6, wherein the different value is selected from the one or more values that are adjacent to a currently selected value.

8. The method of claim 1, wherein the antenna is coupled to a sacrificial component circuit.

9. The method of claim 1, wherein the measured magnitude of the transmitted power is stored in a memory location for subsequent retrieval.

10. A wireless communication system, comprising:
an antenna;
a transmitter; and
a tunable impedance matching network coupled between the transmitter and the antenna having:
a plurality of tunable components; and
control circuitry coupled to the plurality of tunable components, wherein the control circuitry simultaneously adjusts a value of each of the plurality of tunable components and performs a measurement of the transmit power of the antenna in response to each adjustment by the control circuitry to determine values for the plurality of tunable components associated with the maximum power.

11. The wireless communication system of claim 10, wherein the plurality of tunable components includes at least three components.

12. The wireless communication system of claim 10, wherein the control circuitry comprises a plurality of multi-bit registers, and each of the plurality of tunable components being coupled to a respective one of the multi-bit registers.

13. The wireless communication system of claim 12, wherein the control circuit adjusts a value of each of the tunable components based on a value selected from an array of matching values based on the multi-bit register.

14. The wireless communication system of claim 13, wherein the array of matching values are provided in one of a two-dimensional array, a three-dimensional array, and a four-dimensional array.

15. The wireless communication system of claim 12, wherein the plurality of multi-bit registers includes at least five registers.

16. The wireless communication system of claim 10, wherein the control circuitry comprises plurality of multi-bit registers each of which is coupled to a respective one of the plurality of tunable components

17. The wireless communication system of claim 10, wherein each of the plurality of tunable components comprises a capacitor bank having a plurality of capacitors that are individually selectable to provide varying values.

18. The wireless communication system of claim 10, wherein each of the plurality of tunable components comprises at least one of a capacitor, a varactor, an inductor, and combinations thereof

19. The wireless communication system of claim 10, wherein the control circuit adjusts a value of each of the tunable components based on a value selected from an array of matching values.

20. The wireless communication system of claim 10, further comprising a sacrificial component circuit coupled to the antenna.
